(19) United States
(12) Patent Application Publication
(10) Pub. No.: US 2017/0277308 A1
(43) Pub. Date: Sep. 28, 2017

(54) CAPACITIVE TOUCH SCREEN AND METHOD OF MANUFACTURING THE SAME AND TOUCH CONTROL DEVICE

(71) Applicants: BOE Technology Group Co., Ltd., Beijing (CN); Hefei Xinsheng Optoelectronics Technology Co., Ltd., Anhui (CN)

(72) Inventors: Ting Zeng, Beijing (CN); Ming Hu, Beijing (CN); Taofeng Xie, Beijing (CN); Qingpu Wang, Beijing (CN); Jun Li, Beijing (CN); Kefeng Li, Beijing (CN)

(21) Appl. No.: 15/511,083

(22) PCT Filed: Jan. 14, 2016
(86) PCT No.: PCT/CN2016/070859

§ 371 Date: Mar. 14, 2017

(30) Foreign Application Priority Data
Mar. 7, 2015 (CN) 201510391961.4

(51) Int. Cl. G06F 3/044; G06F 3/041

(52) U.S. Cl. CPC G06F 3/044; G06F 3/0412; G06F 2203/04103

(57) ABSTRACT

The present disclosure provides a capacitive touch screen and a method of manufacturing the same and a touch control device. The capacitive touch screen includes a base substrate, transparent electrodes on the base substrate and a transparent insulating layer on the transparent electrodes. Two transparent electrodes that are spaced apart by at least one transparent electrode are electrically connected by the first bridging line provided on the transparent insulating layer, via the through-holes provided in the transparent insulating layer.

### CROSS-REFERENCE TO RELATED APPLICATIONS

This application is a Section 371 National Stage Application of International Application No. PCT/CN2016/070859, filed on Jan. 14, 2016, entitled “capacitive touch screen and a method of manufacturing the same, and a touch control device”, which claims priority to Chinese Application No. 201510391961.4, filed on Jul. 3, 2015, incorporated herein by reference in their entirety.

### BACKGROUND

### 1. Technical Field

The disclosure relates to touch control technique field, and particularly to a capacitive touch screen and a method of manufacturing the same, and a touch control device.

### 2. Description of the Related Art

Existing bridge-type capacitive touch screen has advantages such as good durability, high reliability, multi-point touch-control and the like and is widely used in electronic consumption product field.

Basic operation principle of the capacitive touch screen is to determine a specific position of a touching point on the screen by means of an electrical current induced by a human body. Specifically, a basic operation unit of the capacitive touch screen includes four transparent electrodes, which are respectively located at four corners of the basic operation unit. When a user's finger touches the capacitive touch screen, due to electrical field of human body, a coupling capacitor is generated between the user and the capacitive touch screen. As the capacitor is a direct conductor for a high-frequency current, a small portion of the current is absorbed at the touch point of the capacitive touch screen by the user's finger. The current is formed by currents from the four transparent electrodes at respective four corners of the capacitive touch screen, and amplitudes of the currents flowing through the four transparent electrodes are respectively in direct proportion to distances from the finger to the four corners. Thus, the position of the touch point may be determined by accurately calculating proportions of the four currents.

### SUMMARY

Embodiments of the present disclosure provides a capacitive touch screen and a method of manufacturing the same and a touch control device, which have a simpler overlapped structure, an improved light transmission rate and no bottom shadow at the bridging portions when compared to those capacitive touch screens in prior arts.

Embodiments of the present disclosure provide a capacitive touch screen comprising:

a base substrate;

a plurality of transparent electrodes located in a display region of the base substrate, the plurality of transparent electrodes being provided in a same layer to form a touch sensing matrix; and a transparent insulating layer covered on the transparent electrodes,

wherein the transparent insulating layer is provided therein with through-holes corresponding to the transparent electrodes, and first bridging lines are provided on the transparent insulating layer, such that two transparent electrodes that are spaced apart by at least one transparent electrode are electrically connected by a corresponding one of the first bridging lines via a first portion of the through-holes.

Optionally, the transparent electrodes include first electrodes, each of which is configured in continuous structure in one dimension, and second electrodes configured to be spaced apart from each other by the first electrodes, wherein the first portion of the though-holes are configured to correspond to the second electrodes such that two adjacent second electrodes are electrically connected by a corresponding one of the first bridging lines via the first portion of the through-holes.

Optionally, a black matrix is provided in a peripheral region of the base substrate, and second bridging lines and connection lines are configured on the black matrix, the second bridging lines being in electrical connection with the transparent electrodes, which are close to the black matrix, via a second portion of the through-holes, and the connection lines being in electrical connection with the second bridging lines.

Optionally, the transparent electrodes are made of tin indium oxide.

Optionally, the first bridging lines, the second bridging lines and the connection lines are made of tin indium oxide; or

the first bridging lines, the second bridging lines and the connection lines are made of metal material; or

the first bridging lines and the second bridging lines are made of tin indium oxide and the connection lines are made of metal material.

Optionally, the first bridging lines, the second bridging lines and the connection lines are configured in a same layer and formed through a single patterning process.

Optionally, the transparent insulating layer fully covers the display region.

Optionally, the through-holes each have a shape of circle, rectangle or trapezoid.

Optionally, a touch control device comprising the above capacitive touch screen.

Embodiments of the present disclosure further provide a method of manufacturing a capacitive touch screen, the method comprising:

step S1: forming a plurality of transparent electrodes in a same layer in a display region of a base substrate, the plurality of transparent electrodes forming a touch-sensitive matrix;

step S2: forming a transparent insulating layer covered on the transparent electrodes such that the transparent electrodes are insulated from each other, and the transparent insulating layer is provided therein with through-holes corresponding to the transparent electrodes; and

step S3: forming first bridging lines on the transparent insulating layer such that two transparent electrodes that are spaced apart by at least one transparent electrode are electrically connected by a corresponding one of the first bridging lines via the first portion of the through-holes.

Optionally, the transparent electrodes comprise first electrodes, each of which is configured in continuous structure in one dimension, and second electrodes configured to space apart from each other, wherein the first portion of the though-holes are configured to correspond to the second electrodes such that two adjacent second electrodes are electrically connected by a corresponding one of the first bridging lines via the first portion of the through-holes.

Optionally, prior to step S1, the method further comprises:

forming a black matrix in a peripheral region of the base substrate; and

forming second bridging lines and connection lines on the black matrix while forming the first bridging lines on the transparent insulating layer, the second bridging lines being in electrical connection with the transparent electrodes, which are close to the black matrix via the second portion of the through-holes, and the connection lines being in electrical connection with the second bridging lines.

Optionally, prior to step S1, the method further comprises:

forming a black matrix in a peripheral region of the base substrate; and

forming second bridging lines on the black matrix while forming the first bridging lines on the transparent insulating layer, the second bridging lines being in electrical connection with the transparent electrodes, which are close to the black matrix, the second portion of via the through-holes; and

posterior to step S3, the method further comprises:

forming connection lines on the black matrix, such that the connection lines are in electrical connection with the second bridging lines.

Optionally, the transparent electrode is made of tin indium oxide.

Optionally, the first bridging lines, the second bridging lines and the connection lines are made of tin indium oxide; or

the first bridging lines, the second bridging lines and the connection lines are made of metal material; or

the first bridging lines and the second bridging lines are made of tin indium oxide and the connection lines are made of metal material.

### BRIEF DESCRIPTION OF THE DRAWINGS

FIG. 1 is a structural schematic view of a capacitive touch screen according to an embodiment of the present disclosure.

FIG. 2 is a cross section view of the capacitive touch screen in FIG. 1, taken along A-A line.

FIG. 3 illustrates a flow chart of a method of manufacturing a capacitive touch screen according to an embodiment of the present disclosure.

FIG. 4 illustrates a structural schematic view of a bridging type capacitive touch screen in related art.

FIG. 5 is a plan schematic view illustrating a pattern of X-axis electrodes and Y-axis electrodes in the capacitive touch screen in related art.

FIG. 6 is an enlarged schematic view of a portion A shown in FIG. 5.

### DETAILED DESCRIPTION OF THE EMBODIMENTS

Further description in detailed of a capacitive touch screen and a method of manufacturing the same and a touch control device provided by the present disclosure will be made with reference to the drawings in order to understand the schemes of the present disclosure better.

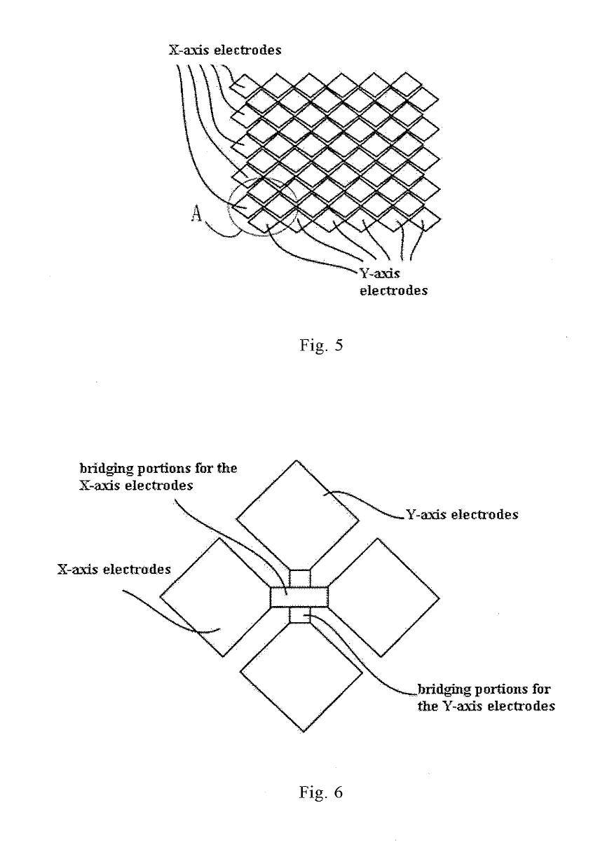

FIG. 4 illustrates a structural schematic view of a bridging capacitive touch screen in related art, FIG. 5 illustrates a plan schematic view of a pattern of X-axis electrodes and Y-axis electrodes in the capacitive touch screen and FIG. 6 is an enlarged schematic view of a portion A of FIG. 5. As shown in FIG. 4, a tin indium oxide (ITO) pattern including a plurality of X-axis electrodes and a plurality of Y-axis electrodes that are arranged in array is formed on an upper surface of a glass base substrate and a shielding ITO layer is formed on a lower surface of the glass base substrate. That is, FIG. 4 shows a single-face ITO (SITO) bridging type capacitive touch screen.

By referring to FIGS. 4 and 5, the X-axis electrodes are physically and electrically connected by bridging portions, each of which is located between two adjacent X-axis electrodes, respectively, and the Y-axis electrodes are physically and electrically connected by bridging portions, each of which is located between two adjacent Y-axis electrodes, respectively. As shown in FIGS. 4 and 6, the bridging portions for the X-axis electrodes cross and are in insulation from the bridging portions for the X-axis electrodes.

However, the above capacitive touch screen has a complex overlapped structure, a low transmission rate and a bottom shadow at the bridging portions, which degrade visual sense effect and performance of the capacitive touch screen. In addition, as ends of each of the bridging portions for the X-axis electrodes have slope portions, ability of electrostatic discharge (ESD) resistance of the capacitive touch screen is degraded.

Other types of capacitive touch screen in related arts, such as a dual-layer SITO or dual-face ITO (DITO) capacitive touch screen, also exist similar problems including complex overlapped structure, a low light transmission rate and the like.

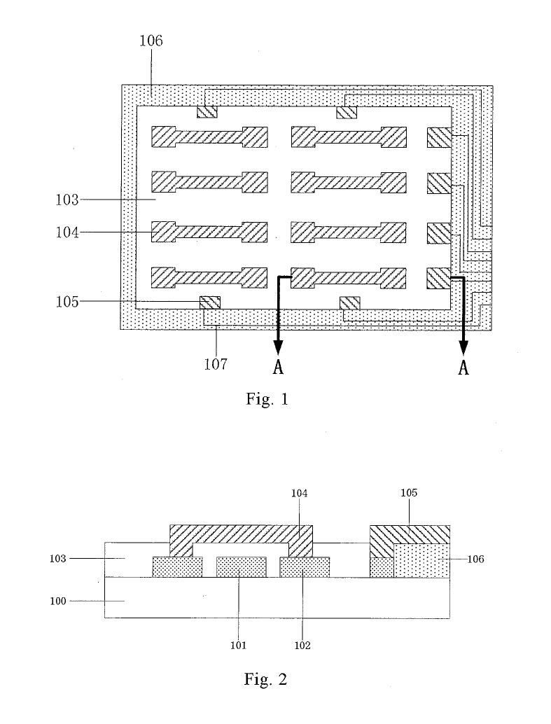

FIG. 1 is a structural schematic view of a capacitive touch screen according to an embodiment of the present disclosure, and FIG. 2 is a cross section view of the capacitive touch screen in FIG. 1, taken along A-A line. As shown in FIGS. 1 and 2, the capacitive touch screen includes a base substrate 100, which includes a display region and a peripheral region. The display region of the base substrate 100 is provided with a plurality of transparent electrodes that are configured in the same layer. In the embodiment, the plurality of transparent electrodes come into being a touch-sensitive matrix and a transparent insulating layer 103 is provided on the transparent electrodes. Preferably, the transparent insulating layer fully covers the display region of the base substrate 100 so as to improve bridging property of the capacitive touch screen. The transparent insulating layer 103 is provided with through-holes corresponding to the transparent electrodes. Optionally, the through-holes have a shape of circle, rectangle or trapezoid. First bridging lines 104 are formed on the transparent insulating layer 103, such that two transparent electrodes that are spaced apart from each other by at least one transparent electrode are electrically connected by the first bridging line 104, via a first portion of the through-holes. According to the capacitive touch screen of the embodiment, overlapped structure may be simplified, transmission rate and shadow eliminating effect may be improved, and thereby visual sense effect and performance of the capacitive touch screen may be improved while product cost may be reduced.

In the embodiment, the transparent electrodes include first electrodes 101, each of which is configured in continuous structure in one dimension, and second electrodes 102 arranged to be spaced apart from each other. For example, as shown in FIG. 2, the first electrodes are each configured in continuous structure in one dimension, that is, each of them is configured in continuous structure in the one dimension as shown in FIG. 2 and the plurality of the first electrodes are not continuous in transverse dimension. The first electrodes 101 and the second electrodes 102 are physically separated and electrically insulated from each other by the transparent insulating layer 103. In addition, the first bridging lines 104 and the first electrodes 101 are also physically separated and electrically insulated from each other by the transparent insulating layer 103. With the configuration, it ensures that both the first electrodes 101 and the second electrodes 102 may be electrically connected in respective directions while short circuit occurring at position where the first electrodes 101 cross the second electrodes 102 may be effectively avoided. The first portion of the though-holes are configured to correspond to the second electrodes 102 such that two spaced second electrodes 102 are electrically connected by a corresponding one of the first bridging lines 104 via the first portion of the through-holes. Compared with the prior art, due to the through-holes, two ends of the bridging portions of the capacitive touch screen have no slope surface and thereby ability of electrostatic discharge resistance of the bridging portions of the capacitive touch screen may be improved.

In the embodiment, the peripheral region of the base substrate 100 is provided with a black matrix 106, on which second bridging lines 105 and connection lines 107 are configured. The second bridging lines 105 are in electrical connection with the transparent electrodes, which are close to the black matrix 106, via a second portion of the through-holes, and the connection lines 107 are in electrical connection with the second bridging lines 105.

In the embodiment, the transparent electrodes are made of tin indium oxide. When the first bridging lines 104, the second bridging lines 105 and the connection lines 107 are formed through a single patterning process, they may be all made of tin indium oxide. In addition, when the first bridging lines 104, the second bridging lines 105 and the connection lines 107 are formed through a single patterning process, they may be made of metal material. When the first bridging lines 104 and the second bridging lines 105 are formed through a single patterning process while the connection lines 107 are formed through another patterning process, the first bridging lines and the second bridging lines may be made of tin indium oxide while the connection lines may be made of metal material.

The capacitive touch screen according to the embodiment includes the base substrate, the plurality of transparent electrodes configured in a same layer in the display region of the base substrate and the transparent insulating layer covered on the transparent electrodes, wherein the transparent insulating layer are configured such that the transparent electrodes are physically spaced and insulated from each other, the transparent insulating layer are provided with through-holes corresponding to the transparent electrodes, the first bridging lines are provided on the transparent insulating layer and two transparent electrodes that are spaced apart by at least one transparent electrode are electrically connected by a corresponding one of the first bridging lines via the first portion of the through-holes. According to the capacitive touch screen of the embodiment, overlapped structure may be simplified, transmission rate and shadow eliminating effect are improved, and thereby visual sense effect and performance of the capacitive touch screen are improved while product cost is reduced.

An embodiment of the present disclosure further provides a touch control device including the capacitive touch screen according to embodiments of present disclosure. For example, the touch control device may include the capacitive touch screen described in the above embodiment. The configuration of the touch control device in detailed may be referred to the above description and is not described repeatedly.

In the touch control device according to the embodiment, the capacitive touch screen includes a base substrate, a plurality of transparent electrodes configured in a same layer in the display region of the base substrate and a transparent insulating layer covered on the transparent electrodes, wherein the transparent insulating layer are configured such that the transparent electrodes are physically spaced and insulated from each other, the transparent insulating layer are provided with through-holes corresponding to the transparent electrodes, first bridging lines are provided on the transparent insulating layer, and two transparent electrodes that are spaced apart by at least one transparent electrode are electrically connected by a corresponding one of the first bridging lines via the first portion of the through-holes. Due to configuration of the capacitive touch screen according to the embodiment of the present disclosure, the touch control device of the embodiment has a simplified structure, an improved transmission rate and a shadow eliminating effect, and thus has a better performance and a lower product cost.

An embodiment of the present disclosure further provides a method of manufacturing a capacitive touch screen. It is noted that other solutions for manufacturing the capacitive touch screen are also covered by the scope of the present disclosure although the embodiments are described in detailed in line with a one glass solution and on-cell solution.

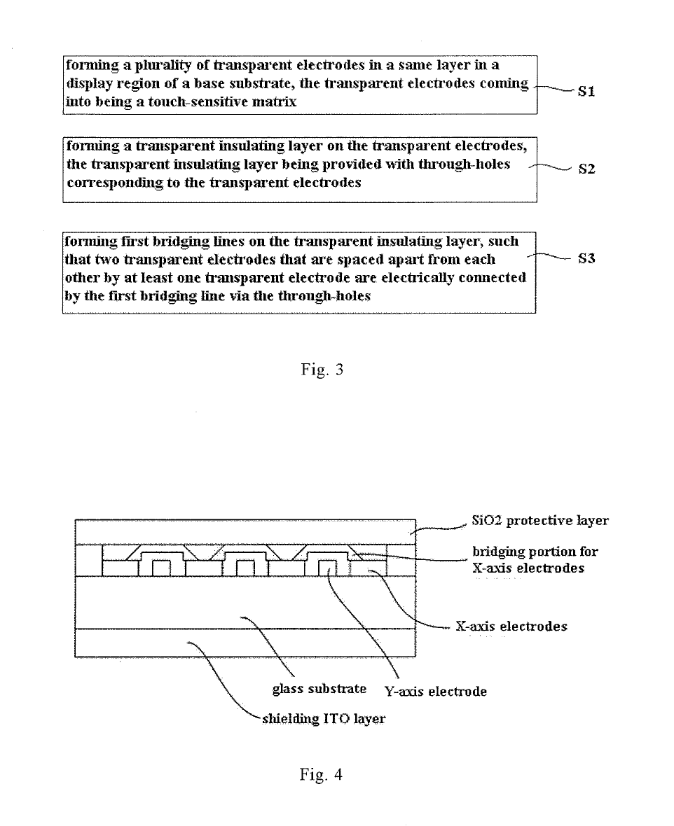

FIG. 3 illustrates a flow chart of a method of manufacturing a capacitive touch screen according to an embodiment of the present disclosure. As shown in FIG. 3, the method of manufacturing a capacitive touch screen includes following steps:

Step S1: forming a plurality of transparent electrodes in a same layer in a display region of a base substrate, the transparent electrodes coming into being a touch-sensitive matrix.

In the embodiment, the capacitive touch screen includes a base substrate that includes a display region and a peripheral region. The display region of the base substrate is provided with a plurality of transparent electrodes that are configured in the same layer. In the embodiment, the plurality of transparent electrodes come into being the touch-sensitive matrix.

Step S2: forming a transparent insulating layer covered on the transparent electrodes such that the transparent electrodes are physically spaced and insulated from each other and the transparent insulating layer is provided with through-holes corresponding to the transparent electrodes.

In the embodiment, the transparent insulating layer is formed on the transparent electrodes. Preferably, the transparent insulating layer fully covers the display region of the base substrate so as to improve bridging property of the capacitive touch screen. The transparent insulating layer is provided with through-holes corresponding to the transparent electrodes. Optionally, the through-holes have a shape of circle, rectangle or trapezoid.

Step S3: forming first bridging lines on the transparent insulating layer, such that two transparent electrodes that are spaced apart from each other by at least one transparent electrode are electrically connected by the first bridging line via a first portion of the through-holes.

In the embodiment, the first bridging lines are formed on the transparent insulating layer and, two transparent electrodes that are spaced apart from each other by at least one transparent electrode are electrically connected by the first bridging line via the portion of the through-holes. Compared with the prior art, the capacitive touch screen manufactured by the method of manufacturing a capacitive touch screen according to the embodiment has a simplified structure, an improved transmission rate and a shadow eliminating effect, and thus has a better visual sense effect and performance and a lower product cost.

In the embodiment, the transparent electrodes include first electrodes, each of which is configured in a continuous structure in one dimension, and second electrodes arranged to be spaced apart from each other by the first electrodes. The first electrodes are separated from the second electrodes by the transparent insulating layer while the first bridging lines are also separated from the first electrodes by the transparent insulating layer. The above configuration may not only ensure both the first electrodes and the second electrodes are electrically connected in their respective directions but also effectively avoid short circuit occurring at position where the first electrodes cross the second electrodes. The first portion of the though-holes are configured to correspond to the second electrodes such that two adjacent second electrodes are electrically connected by a corresponding one of the first bridging lines via the first portion of the through-holes.

In the embodiment, the transparent electrodes are made of tin indium oxide. When the first bridging lines, the second bridging lines and the connection lines are formed through a single patterning process, they may be all made of a tin indium oxide or metal material. Specifically, a black matrix is formed in the peripheral region of the base substrate and, a transparent conductive film is formed in the display region of the base substrate and then is formed into a plurality of transparent electrodes through a patterning process, the plurality of transparent electrodes coming into being a touch-sensitive matrix. A transparent insulating layer film is formed on the transparent electrodes and is then formed as the transparent insulating layer through a patterning process. The transparent insulating layer is provided with the through-holes that correspond to the transparent electrodes. Size and shape of the through-holes may be controlled by controlling parameters of the patterning process (such as, exposure condition and development time period). The through-holes have a shape of circle, rectangle or trapezoid. The through-holes in a shape of circle have an inside diameter in a range from 10 μm to 30 μm. The through-holes in a shape of rectangle have a side length in a range from 10 μm to 30 μm. A transparent conductive film or metal film is formed on the transparent insulating layer and on the black matrix, and then is formed into the first bridging lines, the second bridging lines and the connection lines through a patterning process, such that two transparent electrodes that are spaced apart by at least one transparent electrode are electrically connected by a corresponding one of the first bridging lines via the first portion of the through-holes, the second bridging lines are electrically connected to the transparent electrodes, which are close to the black matrix, via a second portion of the through-holes, and the connection lines are electrically connected to the second bridging lines.

In practice, when the first bridging lines and the second bridging lines are formed through a single patterning process while the connection lines are formed through another patterning process, the first bridging lines and the second bridging lines may be made of tin indium oxide while the connection lines may be made of metal material. Specifically, a black matrix is formed in the peripheral region of the base substrate, a transparent conductive film is formed in the display region of the base substrate and is then formed into the plurality of transparent electrodes through a patterning process. The plurality of transparent electrodes come into being a touch-sensitive matrix. A transparent insulating film is formed on the transparent electrodes and is formed into the transparent insulating layer through a patterning process. The transparent insulating layer is provided with through-holes corresponding to the transparent electrodes. Size and shape of the through-holes may be controlled by controlling parameters of the patterning process (such as, exposure condition and development time period). The through-holes have a shape of circle, rectangle or trapezoid. The through-holes in a shape of circle may have an inside diameter in a range from 10 μm to 30 μm. The through-holes in a shape of rectangle may have a side length in a range from 10 μm to 30 μm. A transparent conductive film is formed on the transparent insulating layer and the black matrix, and is formed into the first bridging lines, the second bridging lines and the connection lines through a patterning process, such that two transparent electrodes that are spaced apart by at least one transparent electrode are electrically connected by a corresponding one of the first bridging lines via the through-holes, and the second bridging lines are electrically connected to the transparent electrodes, which are close to the black matrix, via the through-holes. A metal film is formed on the black matrix and is formed into the connection lines through a patterning process. The connection lines are electrically connected to the second bridging lines.

A method of manufacturing a capacitive touch screen according to an embodiment includes: forming a plurality of transparent electrodes in a same layer in a display region of the base substrate, the plurality of transparent electrodes forming a touch-sensitive matrix; forming a transparent insulating layer covered on the transparent electrodes such that the transparent electrodes are physically spaced and insulated from each other, the transparent insulating layer being provided with through-holes, corresponding to the transparent electrodes; and, forming first bridging lines on the transparent insulating layer such that two transparent electrodes that are spaced apart by at least one transparent electrode are electrically connected with each other by a corresponding one of the first bridging lines via the first portion of the through-holes. Compared with the prior art, the capacitive touch screen manufactured by the method of manufacturing a capacitive touch screen according the embodiment has a simplified structure, an improved light transmission rate and a shadow eliminating effect, and thus has a better visual sense effect and performance and a lower product cost.

It is understood that that the above embodiments are merely exemplary embodiments that are intended to illustrate principles of the present disclosure and scope of the present disclosure will not be limited to those. Any modification and improvement may be made within the spirit and scope of the present disclosure by those skilled in the art and shall be included in the protective scope of the present invention.

1. A capacitive touch screen, comprising:
a base substrate;
a plurality of transparent electrodes located in a display region of the base substrate, the plurality of transparent electrodes being provided in a same layer to form a touch sensing matrix; and
a transparent insulating layer covered on the transparent electrodes such that the transparent electrodes are physically spaced and insulated from each other,
wherein the transparent insulating layer is provided therein with through-holes corresponding to the transparent electrodes, and first bridging lines are provided on the transparent insulating layer, such that two transparent electrodes that are spaced apart by at least one transparent electrode are electrically connected by a corresponding one of the first bridging lines via the through-holes.

2. The capacitive touch screen according to claim 1, wherein the transparent electrodes include first electrodes, each of which is configured in continuous structure in one dimension, and second electrodes configured to be spaced apart from each other by the first electrodes, wherein the first portion of the though-holes are configured to correspond to the second electrodes such that two adjacent second electrodes are electrically connected by a corresponding one of the first bridging lines via the first portion of the through-holes.

3. The capacitive touch screen according to claim 1, wherein a black matrix is provided in a peripheral region of the base substrate, and second bridging lines and connection lines are configured on the black matrix, the second bridging lines being in electrical connection with the transparent electrodes, which are close to the black matrix, via a second portion of the through-holes, and the connection lines being in electrical connection with the second bridging lines.

4. The capacitive touch screen according to claim 1, wherein the transparent electrodes are made of tin indium oxide.

5. The capacitive touch screen according to claim 3, wherein the first bridging lines, the second bridging lines and the connection lines are made of tin indium oxide; or
the first bridging lines, the second bridging lines and the connection lines are made of metal material; or
the first bridging lines and the second bridging lines are made of tin indium oxide and the connection lines are made of metal material.

6. The capacitive touch screen according to claim 3, wherein the first bridging lines, the second bridging lines and the connection lines are configured in a same layer and formed through a single patterning process.

7. The capacitive touch screen according to claim 1, wherein the transparent insulating layer fully covers the display region.

8. The capacitive touch screen according to claim 1, wherein the through-holes each have a shape of circle, rectangle or trapezoid.

9. A touch control device comprising the capacitive touch screen according to claim 1.

10. A method of manufacturing a capacitive touch screen, the method comprising:
step S1: forming a plurality of transparent electrodes in a same layer in a display region of a base substrate, the plurality of transparent electrodes forming a touch-sensitive matrix;
step S2: forming a transparent insulating covered on the transparent electrodes such that the transparent electrodes are physically spaced and insulated from each other and the transparent insulating layer is provided therein with through-holes corresponding to the transparent electrodes; and
step S3: forming first bridging lines on the transparent insulating layer such that two transparent electrodes that are spaced apart by at least one transparent electrode are electrically connected by a corresponding one of the first bridging lines via a first portion of the through-holes.

11. The method of manufacturing a capacitive touch screen according to claim 10, wherein the transparent electrodes comprise first electrodes, each of which is configured in continuous structure in one dimension, and second electrodes configured to space apart from each other by the first electrodes, wherein the first portion of the though-holes are configured to correspond to the second electrodes such that two adjacent second electrodes are electrically connected by a corresponding one of the first bridging lines via the first portion of the through-holes.

12. The method of manufacturing a capacitive touch screen according to claim 10, wherein, prior to step S1, the method further comprises:
forming a black matrix in a peripheral region of the base substrate; and
forming second bridging lines and connection lines on the black matrix while forming the first bridging lines on the transparent insulating layer, the second bridging lines being in electrical connection with the transparent electrodes, which are close to the black matrix via a second portion of the through-holes, and the connection lines being in electrical connection with the second bridging lines.

13. The method of manufacturing a capacitive touch screen according to claim 10, wherein, prior to step S1, the method further comprises:
forming a black matrix in a peripheral region of the base substrate; and
forming second bridging lines on the black matrix while forming the first bridging lines on the transparent insulating layer, the second bridging lines being in electrical connection with the transparent electrodes, which are close to the black matrix, via the second portion of the through-holes; and
posterior to step S3, the method further comprises:
forming connection lines on the black matrix, such that the connection lines are in electrical connection with the second bridging lines.

14. The method of manufacturing a capacitive touch screen according to claim 10, wherein, the transparent electrode is made of tin indium oxide.

15. The method of manufacturing a capacitive touch screen according to claim 12, wherein,
the first bridging lines, the second bridging lines and the connection lines are made of tin indium oxide; or
the first bridging lines, the second bridging lines and the connection lines are made of metal material; or
the first bridging lines and the second bridging lines are made of tin indium oxide and the connection lines are made of metal material.

16. The method of manufacturing a capacitive touch screen according to claim 13, wherein,
the first bridging lines, the second bridging lines and the connection lines are made of tin indium oxide; or
the first bridging lines, the second bridging lines and the connection lines are made of metal material; or
the first bridging lines and the second bridging lines are made of tin indium oxide and the connection lines are made of metal material.
